(19) United States
(12) Patent Application Publication
(10) Pub. No.: US 2008/0216015 A1
(43) Pub. Date: Sep. 4, 2008

(54) Method of Displaying Atypical Template Type on Idle-Mode Screen of Mobile Communication Terminal, Computer-Readable Recording Medium in Which Program For Executing the Same is Recorded and Mobile Communication Terminal With Function Thereof

(76) Inventor: Chang Seok Lee, Seoul (KR)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/913,988

(22) PCT Filed: Nov. 21, 2005
(86) PCT No.: PCT/KR05/03933

§ 371 Date: Nov. 9, 2007

(30) Foreign Application Priority Data
May 10, 2005 (KR) 10-2005-0038702

(51) Int. Cl. G06F 3/048

(52) U.S. Cl. 715/810

(57) ABSTRACT

The present invention relates to a mobile communication terminal having an idle screen function, and more particularly, to a method of atypically displaying idle screen templates of a mobile communication terminal. A method of displaying atypical template types on an idle-mode screen of a mobile communication terminal according to the present invention includes the steps of selecting any one of atypical template types that have been previously set to display the selected template type on the idle-mode screen of the mobile communication terminal, checking a setting value (properties or profiles) of the selected atypical template type, configuring a channel using the atypical template type constructed based on the setting value, and changing a template type of the idle-mode screen from a template type that has already been displayed to the selected atypical template type, and displaying the changed template type on the idle-mode screen.

### TECHNICAL FIELD

The present invention relates to a mobile communication terminal having an idle screen function, and more particularly, to a method of atypically displaying idle screen templates of a mobile communication terminal.

### BACKGROUND ART

With the development of wireless Internet services, user-oriented information services have become available. The development of user-oriented services has lead to the popularization of the wireless Internet.

Generally, in a wireless Internet service system, information is transmitted to a user in a Short Message Service (SMS) form. Information received by way of SMS is stored as a simple message in a mobile communication terminal apparatus. As a result, multimedia information such as financial information and entertainment banners are not consistently displayed to a user.

In a current wireless Internet service system, the use of multimedia information has increased due to the adoption of a color screen in the mobile communication terminal, the high specification of the mobile communication terminal and the increased speed of the wireless Internet.

In the art related to the transmission of information, there was a time when a user could only receive information selected by the services provider to be transmitted through a SMS service. However, a problem arose in that a user could not select the financial and entertainment information.

In addition, in the art related to the information transmission service using a SMS service, the amount of data that could be transmitted at one time was limited. However, a problem arose in that data of audio or video form cannot be transmitted to a user.

Furthermore, the prior art information transmission SMS service was adapted to simply transfer information. Such a service was problematic in that it did not provide a user with interactive capability whereby the user could gain access to a related wireless Internet site through a hyperlink function.

Furthermore, the prior art was problematic in that a user had to acquire information through direct access using an Internet access application or a browser embedded in a mobile communication terminal and, such as it was impossible to provide information specified for each user.

To solve the above problems, the applicant of the present invention has filed PCT/KR2004/00089 entitled “APPARATUS AND METHOD FOR CONTROLLING AND OPERATING IDLE SCREEN RESOURCE IN MOBILE COMMUNICATION TERMINAL APPARATUS”.

FIG. 1 shows where information is provided to templates displayed on an idle-mode screen of a mobile communication terminal in PCT application entitled “APPARATUS AND METHOD FOR CONTROLLING AND OPERATING IDLE SCREEN RESOURCE IN MOBILE COMMUNICATION TERMINAL APPARATUS”, which was filed by the application of the present invention.

As shown in FIG. 1, the idle-mode screen 100 of the mobile communication terminal has various templates 101 displayed thereon. The template types 101 are disadvantageous in that regions 101a to 101d on which information is displayed is fixed, and cannot be moved.

### DISCLOSURE OF INVENTION

### Technical Problem

Accordingly, the present invention has been made in view of the above problems occurring in the prior art, and it is an object of the present invention to provide atypical template types such that a variety of contents are atypically displayed on an idle-mode screen of a mobile communication terminal.

### Technical Solution

To achieve the above object, a method of displaying idle screen atypical template types of a mobile communication terminal according to the present invention includes the steps of (a) accepting the atypical template type which is selected from any one of the atypical template types by user, (b) checking a setting value (properties or profiles) of the accepted atypical template type, (c) configuring a channel according to the accepted atypical template type based on the setting value and changing a template type in accordance with the accepted template type in which the channel is configured.

The selection of the atypical template type in the step (a) may be performed using a template type change application program within the mobile communication terminal or through a web or a WAP.

In the case where the atypical template type is changed using the application program, an atypical template type code corresponding to the changed template type is transmitted to a service server. Meanwhile, in the case where the atypical template type is changed through the web or the WAP, an atypical template type code corresponding to the changed template type is transmitted from the service server to the mobile communication terminal.

The setting value in the step (b) may include one or more of the following color information, the range of an arrangeable coordinate value, a viewpoint, the number of the greatest objects and font information of the atypical template type.

The method may further include the steps of: after the step (c), (c-1) determining whether information contents has been set in each of the configured channels, and (c-2) if it has been determined that there is any channel in which the information content has not been set, setting desired information content is set so that the desired information content can be set in the channel.

The step (c) of configuring the channel may include the steps of checking a Graphic User Interface (GUI) object corresponding to the channel that should be configured, and locating a coordinate value of the GUI object so that the coordinated value is included in a range of an arrangeable coordinate value, i.e., the setting value in step (b).

In the step (c-2), the desired information content is received from the service server by requesting the desired information content from the service server, by selecting allocated information content that has already been received within the mobile communication terminal, or by selecting a build-in function of the mobile communication terminal.

Information content that is requested from the service server is transmitted as a contents code.

The channel included in the selected atypical template type is a sliding region on which characters or images are displayed while being moved or a multimedia region on which images or motion picture are displayed.

According to the present invention, there is provided a computer-readable recording medium in which a program for executing a method of displaying atypical template types on an idle-mode screen of a mobile communication terminal is recorded, the method comprising the steps of (a) accepting the atypical template type which is selected from any one of the atypical template types by user, (b) checking a setting value (properties or profiles) of the accepted atypical template type, (c) configuring a channel according to the accepted atypical template type based on the setting value and changing a template type in accordance with the accepted template type in which the channel is configured.

A mobile communication terminal in which atypical template types for an idle-mode screen can be changed/displayed according to the present invention includes a selection means for selecting any one of atypical template types that have been previously set to display the selected template type on the idle-mode screen of the mobile communication terminal, a check means for checking a setting value (properties or profiles) of the selected atypical template type, a change means for configuring a channel using the atypical template type constructed based on the setting value and changing a template type of the idle-mode screen from a template type that has already been displayed to the selected atypical template type, and a display means for displaying the changed template type on the idle-mode screen.

The selection means selects the selected template type using a template type change application program within the mobile communication terminal or through a web or a WAP.

In the case where the atypical template type is changed using the application program, an atypical template type code corresponding to the changed template type is transmitted to a service server. Meanwhile, in the case where the atypical template type is changed through the web or WAP, an atypical template type code corresponding to the changed template type is transmitted from the service server to the mobile communication terminal.

The setting value includes one or more of the following color information, the range of an arrangeable coordinate value, a viewpoint, the number of the greatest objects and font information of the atypical template type.

The change means includes a GUI check means for checking a GUI object corresponding to the channel that needs to be configured and a means for locating a coordinate value of the GUI object within a range of an arrangeable coordinate value of the setting value.

The change means may further include a information content check means for determining whether the information content has been set in each of the configured channels and a contents setting means for setting the desired information content so that the desired information content can be set in a channel, if it is determined that there is any channel in which the contents information is not set.

The desired information content is received from the service server by requesting the desired information content from the service server, by selecting allocated information content that has already been received within the mobile communication terminal, or by selecting a build-in function of the mobile communication terminal.

Information content that is requested from the service server is transmitted as a contents code.

The channel included in the selected atypical template type is a sliding region on which characters or images are displayed while being moved or a multimedia region on which images or motion picture is displayed.

### ADVANTAGEOUS EFFECTS

As described above, in accordance with the present invention, there is provided template types that are atypically displayed on an idle-mode screen of a mobile communication terminal. Therefore, a variety of information content is located on the idle-mode screen and then displayed.

### BRIEF DESCRIPTION OF THE DRAWINGS

Further objects and advantages of the invention can be more fully understood from the following detailed description taken in conjunction with the accompanying drawings in which:

FIG. 1 shows where contents are provided to templates displayed on an idle-mode screen of a mobile communication terminal in the PCT application entitled “APPARATUS AND METHOD FOR CONTROLLING AND OPERATING IDLE SCREEN RESOURCE IN MOBILE COMMUNICATION TERMINAL APPARATUS”, which was filed by the application of the present invention.

FIG. 2 shows the configuration of a system for displaying idle-mode screen atypical template types of a mobile communication terminal according to the present invention;

FIG. 3 is a flowchart for illustrating a method of displaying idle-mode screen atypical template types of a mobile communication terminal according to the present invention;

FIG. 4 shows an embodiment of a method of displaying atypical template types on an idle-mode screen of a mobile communication terminal according to the present invention; and

FIG. 5 shows another embodiment of a method of displaying atypical template types on an idle-mode screen of a mobile communication terminal according to the present invention.

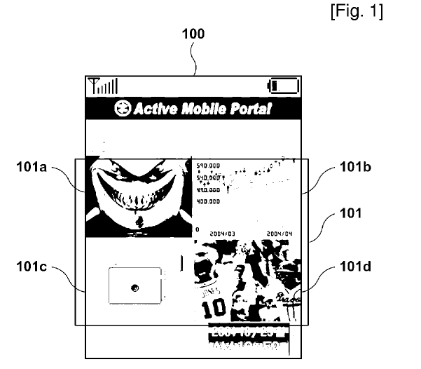

### BEST MODE FOR CARRYING OUT THE INVENTION

The present invention will now be described in detail in connection with preferred embodiments with reference to the accompanying drawings. Like reference numerals are used to identify the same or similar parts.

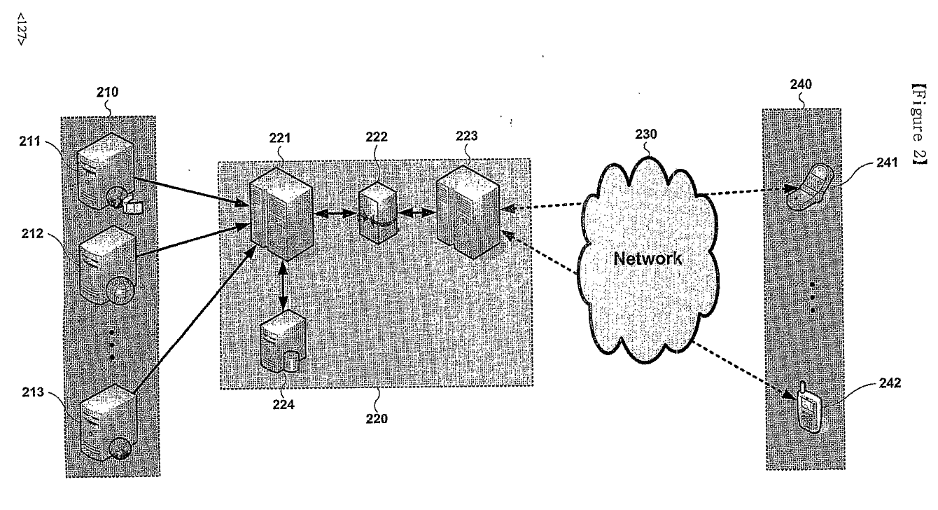

FIG. 2 shows the configuration of a system for displaying idle-mode screen atypical template types of a mobile communication terminal according to the present invention.

As shown in FIG. 2, the system for displaying idle-mode screen atypical template types of the mobile communication terminal includes a contents server unit 210, a service server unit 220, a communication network 230 and a client unit 240.

The contents server unit 210 includes servers for providing a variety of information contents, such as a multimedia-providing server 211, a server 212 for providing information content from a newspaper company, an on-line portal company or a university and a server 213 for providing personal web sites.

The server refers to a server that provides various types of information content from multiple servers.

The service server unit 220 includes a service server 221, a gateway 222 of a mobile communication service provider, a mobile communication service provider server 223 and a template server 224.

The service server 221 includes a system for providing information on idle-mode screens of the mobile communication terminals 241, 242 of the client unit 240 in a character message form.

In the gateway 222 of the mobile communication service provider, information necessary to provide contents from the service server 221 to the client unit 240 is collected by the mobile communication service provider server 223 to integrally process the information.

The mobile communication service provider server 223 provides the client unit 240 with information content using the communication network 230.

The template server 224 provides template types in which a variety of information content, provided from the service server 221 to the client unit 240, will be displayed.

The template server 224 is separately provided in consideration of increased network users or network efficiency, as shown in FIG. 2. If the remaining capacity of a server is sufficient, the template server 224 is built in the service server 221.

That is, the template server 224 provides the service server 221 with information content corresponding to the various template types selected by each user and also provides information content to atypical template types and setting values which are color information, the range of an arrangeable coordinate value, a viewpoint, the number of the greatest objects and/or font information to each user.

The client unit 240 includes mobile communication terminals 241, 242.

The mobile communication terminals 241, 242 are mobile communication terminal capable of providing the idle-mode screen.

As a result, template types that will be displayed through the idle-mode screens of the mobile communication terminals 241, 242 are constructed atypically to create a system that provides atypical template types in which a variety of information types can be displayed.

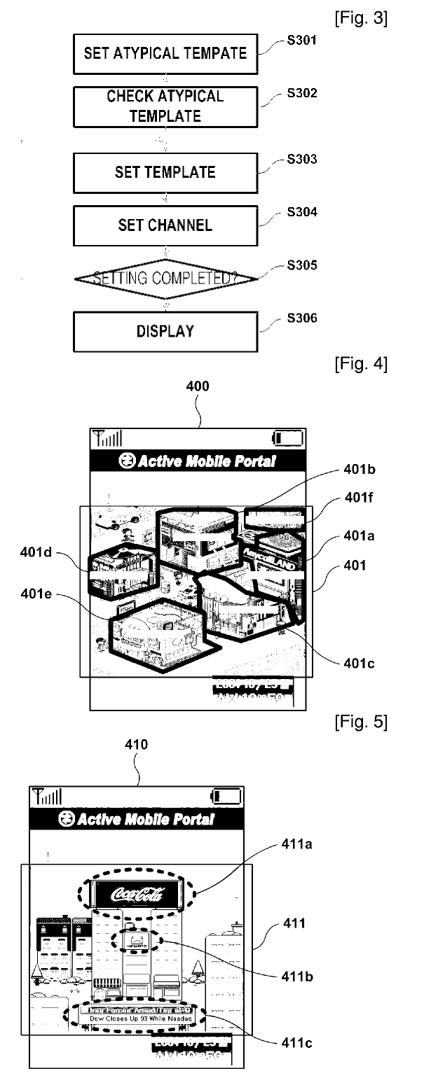

FIG. 3 is a flowchart for illustrating a method of displaying idle-mode screen atypical template types of a mobile communication terminal according to the present invention.

Referring to FIG. 3, any one of the atypical template types that have been previously set is selected to display the template type on the idle-mode screen of the mobile communication terminal at step S301.

The atypical template type can be selected using a template type change application program within the mobile communication terminal or through a web or a Wireless Application Protocol (WAP). In the case where the atypical template type is changed through the application program, an atypical template type code corresponding to the changed template type is transmitted to the service server. In the case where the atypical template type is changed through the web or the WAP, an atypical template type code corresponding to the changed template type is transmitted from the service server to the mobile communication terminal.

A setting value of the selected atypical template type is checked at step S302.

The setting value can include one or more of the following color information, the range of an arrangeable coordinate value, a viewpoint, the number of the greatest objects and font information of the atypical template type.

A channel is configured according to the atypical template type constructed based on the setting value. The template type of the idle-mode screen is changed from a template type that has already been displayed to the selected atypical template type at step S303.

A Graphic User Interface (GUI) object corresponding to a channel that needs to be configured is checked. A coordinate value (i.e., the setting value of the GUI object) is located within the range of the arrangeable coordinate value.

A determination is made as to the information content has been in each configured channel. If there is a channel in which information content has not been set according to the determination result, the desired information content is allocated to a channel.

Desired information content can be allocated to a channel by receiving it from the service server by requesting the service server or selecting information content that has been received within the mobile communication terminal.

Information content that is requested from the service server is transmitted as a contents code.

The changed template type is displayed on the idle-mode screen at step S304.

A channel included in the selected atypical template type consists of a sliding region on which characters or images are displayed while being moved or a multimedia region on which images or motion picture are displayed.

FIG. 4 shows an embodiment of a method of displaying atypical template types on an idle-mode screen of a mobile communication terminal according to the present invention.

As shown in FIG. 4, the idle-mode screen 400 of the mobile communication terminal displays atypical contents display regions 401a to 401f.

An object for each of the display regions is obtained, a setting value for the object is read, and the setting value is displayed on the idle-mode screen of the mobile communication terminal. In this method, setting values, such as coordinate values, are read and information content is then atypically displayed such that the information content, which was displayed by previously setting each region on the idle-mode screen in the related art, can be set atypically.

In this case, six atypical information content are displayed on the idle-mode screen. However, this amount can vary depending on the performance of a processor that processes the idle-mode screen of the mobile communication terminal or on a provider's service policy.

FIG. 5 shows another embodiment of a method of displaying atypical template types on an idle-mode screen of a mobile communication terminal according to the present invention.

As shown in FIG. 5, the idle-mode screen 410 of the mobile communication terminal includes atypical contents display regions 411a to 411c.

An object for each of the display regions is obtained, a setting value for the object is read, and the setting value is displayed on the idle-mode screen of the mobile communication terminal. In this method, setting values, such as coordinate values, are read and information content is then atypically displayed such that the information content, which was displayed by previously setting each region on the idle-mode screen in the related art, can be set atypically.

The idle-mode screen can also be used in various ways by allocating a channel for one information content on the idle-mode screen of the mobile communication to a built-in function of the mobile communication terminal.

In this case, six atypical information contents are displayed on the idle-mode screen. However, this amount can vary depending on the performance of a processor that processes the idle-mode screen of the mobile communication terminal or on a provider's service policy.

### INDUSTRIAL APPLICABILITY

As described above, in accordance with the present invention, there is provided template types that can be atypically displayed on an idle-mode screen of a mobile communication terminal. Therefore, a variety of information content can be located on the idle-mode screen and then displayed.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A method of displaying atypical template types on an idle-mode screen of a mobile communication terminal, comprising the steps of:
(a) accepting the atypical template type which is selected from any one of the atypical template types by user;
(b) checking a setting value (properties or profiles) of the accepted atypical template type;
(c) configuring a channel according to the accepted atypical template type based on the setting value and changing a template type in accordance with the accepted template type in which the channel is configured.

2. The method as claimed in claim 1, wherein the selection of the atypical template type in the step (a) is performed using a template type change application program within the mobile communication terminal or through a web or a Wireless Application Protocol (WAP).

3. The method as claimed in claim 2, wherein in the case where the atypical template type is selected using the application program, an atypical template type code corresponding to the changed template type is transmitted to a service server.

4. The method as claimed in claim 2, wherein in the case where the atypical template type is selected through the web or WAP, an atypical template type code corresponding to the changed template type is transmitted from the service server to the mobile communication terminal.

5. The method as claimed in claim 1, wherein the setting value in the step (b) includes one or more of the following color information, the range of an arrangeable coordinate value, a viewpoint, the number of the greatest objects and font information of the atypical template type.

6. The method as claimed in claim 1, further including the steps of: after the step (c),
(c-1) determining whether information content has been allocated in each of the configured channels; and
(c-2) if it has been determined that information content has not been allocated in the step (c-1), allocating the desired information content to a channel.

7. The method as claimed in claim 6, wherein the step (c) of configuring the channel includes the steps of:
checking a Graphic User Interface (GUI) object corresponding to the channel that should be configured; and
locating a coordinate value of the GUI object so that the coordinated value is included in a range of an arrangeable coordinate value, i.e., the setting value in the step (b).

8. The method as claimed in claim 6, wherein in the step (c-2), the desired information content can be allocated by selecting the information content that has already been received within the mobile communication terminal.

9. The method as claimed in claim 8, wherein the information content is transmitted or received as a content code.

10. The method as claimed in claim 1, wherein the channel included in the selected atypical template type is a sliding region on which characters or images are displayed while being moved, or a multimedia region on which images or motion picture are displayed.

11. A computer-readable recording medium in which a program for executing a method of displaying atypical template types on an idle-mode screen of a mobile communication terminal is recorded, the method comprising the steps of:
(a) accepting the atypical template type which is selected from any one of the atypical template types by user;
(b) checking a setting value (properties or profiles) of the accepted atypical template type;
(c) configuring a channel according to the accepted atypical template type based on the setting value and changing a template type in accordance with the accepted template type in which the channel is configured.

12. A mobile communication terminal in which atypical template types for an idle-mode screen can be changed/displayed, comprising:
selection means for selecting any one of atypical template types that have been previously set to display the selected template type on the idle-mode screen of the mobile communication terminal;
check means for checking a setting value (properties or profiles) of the selected atypical template type;
change means for configuring a channel using the atypical template type constructed based on the setting value, and changing a template type of the idle-mode screen from a template type that has already been displayed to the selected atypical template type; and
display means for displaying the changed template type on the idle-mode screen.

13. The mobile communication terminal as claimed in claim 12, wherein the selection means selects the selected template type using a template type change application program within the mobile communication terminal or through a web or a WAP.

14. The mobile communication terminal as claimed in claim 13, wherein the atypical template type is selected using the application program, an atypical template type code corresponding to the changed template type is transmitted to a service server.

15. The mobile communication terminal as claimed in claim 13, wherein the atypical template type is changed through the web or the WAP, an atypical template type code corresponding to the changed template type is transmitted from the service server to the mobile communication terminal.

16. The mobile communication terminal as claimed in claim 12, wherein the setting value includes one or more of the following color information, the range of an arrangeable coordinate value, a viewpoint, the number of the greatest objects and font information of the atypical template type.

17. The mobile communication terminal as claimed in claim 12, wherein the change means includes:
a GUI check means for checking a GUI object corresponding to the channel that needs to be configured; and
a means for locating a coordinate value of the GUI object within a range of an arrangeable coordinate value of the setting value.

18. The mobile communication terminal as claimed in claim 12, wherein the change means further includes:
an information content check means for determining whether information content has been set in each of the configured channels; and
an information content setting means for setting a desired information content so that the desired information content can be set in a channel, if it has been determined that there is any channel in which the information content has not been set.

19. The mobile communication terminal as claimed in claim 18, wherein the desired information content is received from the service server by requesting the desired information content from the service server, by selecting allocated information content that has already been received within the mobile communication terminal, or by selecting a build-in function of the mobile communication terminal.

20. The mobile communication terminal as claimed in claim 19, wherein information content that is requested from the service server is transmitted as a contents code.

21. The mobile communication terminal as claimed in claim 12, wherein the channel included in the selected atypical template type is a sliding region on which characters or images are displayed while being moved or a multimedia region on which images or motion picture is displayed.
